(19) United States
(12) Patent Application Publication
(10) Pub. No.: US 2007/0094335 A1
(43) Pub. Date: Apr. 26, 2007

(54) Systems and methods for providing a visual indicator of magnitude

(75) Inventor: Edgar A. Tu, Castro Valley, CA (US)

Correspondence Address: CARR & FERRELL LLP, 2200 GENG ROAD, PALO ALTO, CA, 94303, US

(73) Assignee: Sony Computer Entertainment Inc.

(21) Appl. No.: 11/256,520

(22) Filed: Oct. 20, 2005

(51) Int. Cl. G06F 15/16

(52) U.S. Cl. 709/206

(57) ABSTRACT

A system and method for providing a visual indicator of magnitude is provided. The method comprises displaying a visual indicator in association with a network space. A magnitude associated with the network space is then measured. The visual indicator is changed according to the measured magnitude.

### BACKGROUND OF THE INVENTION

1. Field of the Invention

The present invention relates generally to web site counters, and more particularly to systems and methods for providing a visual indicator of magnitude.

2. Description of Related Art

Conventionally, web sites may include counters for indicating to visitors of the web site how many other visitors have visited the particular web site. Typically the counter lets visitors know how popular the web site has become, by showing the number of “hits” for the web site. The counter may also be useful for providing the particular visitor with a number indicating where the particular visitor falls in the numbering system with respect to other visitors.

Counters may also be useful for letting owners of the web site know how many visitors visit the web site. The web sites owner(s) may improve or change the web site in response to a greater number of visitors, for example. Sometimes, the counters provide the number of visitors to the owners, a system administrator, or other person other than the visitor, without also conveying the number to the visitors. Accordingly, the counters may keep the number of visitors to the web site from the visitors visiting the web site.

Although some counters display numbers to the visitors, the numbers typically only reveal how many visitors have visited the web site. In other words, the counters do not divulge precisely what the visitors did while visiting the web site or exactly what information on the web site the visitors interacted with during the visit. Further, the counters are often overlooked by visitors when they are displayed to the visitors because the counters typically are merely numbers and not aesthetically interesting.

Therefore, there a system and method for providing a visual indicator for measuring magnitude is provided.

### SUMMARY OF THE INVENTION

The present invention provides a system and method for providing a visual indicator of magnitude. In a method according to one embodiment, a visual indicator is displayed in association with a network space. A magnitude associated with the network space is then measured. The visual indicator is changed according to the measured magnitude.

### BRIEF DESCRIPTION OF THE DRAWINGS

FIG. 1 illustrates an exemplary environment for providing a visual indicator of magnitude, in one embodiment in accordance with the present invention;

FIG. 2 illustrates an exemplary graphical user interface (GUI) engine for interfacing with the visual indicator, in one embodiment in accordance with the present invention;

FIG. 3 illustrates an exemplary digital device for implementing the visual indicator and the GUI engine, in one embodiment in accordance with the present invention;

FIG. 4 illustrates exemplary server activity for modifying the visual indicator in response to user activity, in one embodiment in accordance with the present invention; and

FIG. 5 illustrates a flow diagram of an exemplary process for providing a visual indicator of magnitude, in one embodiment in accordance with the present invention.

### DESCRIPTION OF EXEMPLARY EMBODIMENTS

A visual indicator of magnitude is provided. The visual indicator may comprise any symbol, icon, or any other graphical indicator. The visual indicator changes as a magnitude or count associated with the visual indicator (e.g., an icon) changes. The visual indicator may increase in size, decrease in size, increase in number, decrease in number, become brighter, become more intense, change colors, blink at a steady or varying rate, and so forth in response to a measured magnitude associated with a file on a network, a web site, or a webpage. For example, the visual indicator may increase in size in order to indicate to users or to a system administrator that the number of visitors to a particular web site is increasing.

In another example, a visual indicator may be placed around a thumbnail of a photograph (e.g., a .jpg file) displayed on a web site or file listing of a network to indicate a magnitude corresponding to the number of views of the photograph by users. Having the visual indicator around the photograph (e.g., placing a colored border around the thumbnail), and/or increasing the size of the visual indicator as still more users view the photograph, provides a user a rapid indication of the popularity of the photograph. In a still further example, the visual indicator may be placed around a display of a network node in a listing of nodes of the network (e.g., network directory tree) in order to indicate a high degree of activity at the network node. Any change to the visual indicator is considered to be within the scope of various embodiments. Further, the change to the visual indicator may occur in response to any type of situation according to various embodiments, as set forth in further detail herein.

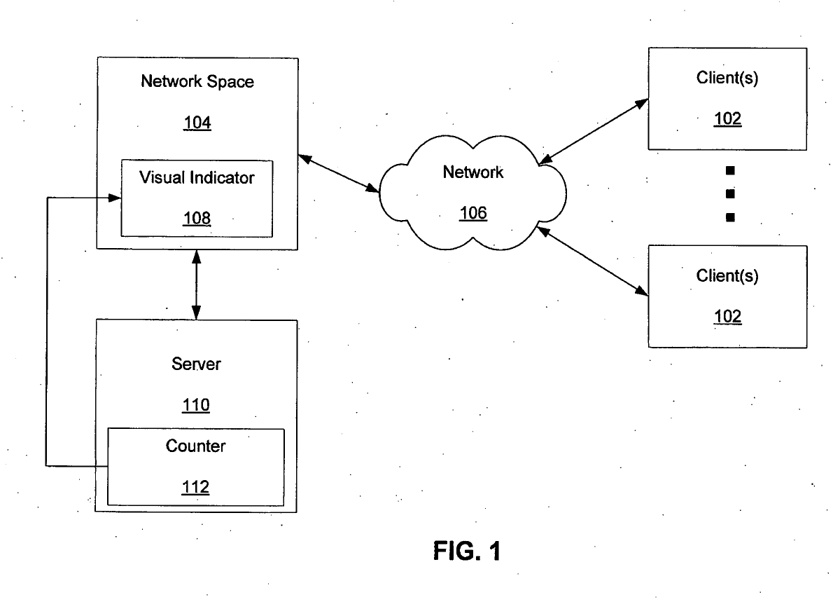

Turning now to FIG. 1, an exemplary environment for providing a visual indicator of magnitude is illustrated, in one embodiment in accordance with the present invention. One or more clients 102 are connected to network space 104, such as a web site, via a network 106. Accordingly, one or more users associated with the client(s) 102 can interact with the network space 104.

The network space 104 includes a visual indicator 108. More than one visual indicator 108 may be displayed in association with each network space 104. The visual indicator 108 may comprise any symbol, icon, and so forth. The visual indicator 108 can illustrate various magnitudes, such as counts, associated with the one or more users that interact with the network space 104.

A server 110 is coupled to the network space 104. The server 110 may include a counter 112 for providing a count that may be utilized for changing the visual indicator 108 at the network space 104 as a consequence of the magnitudes measured by the counter 112 in response to user interaction with the network space 104. For example, the counter 112 may change the visual indicator 108 by increasing the size of the visual indicator 108 as more users interact with the network space 104.

Any type of counter 112 may be provided for measuring user interaction with the network space 104. Further, any type of device may measure user interaction with the network space 104. The user interaction may include any type of activity occurring in relation to the network space 104. For example, in some embodiments, the counter 112 measures the number of users that support a candidate, a point of view, a player, and so forth associated with the network space 104.

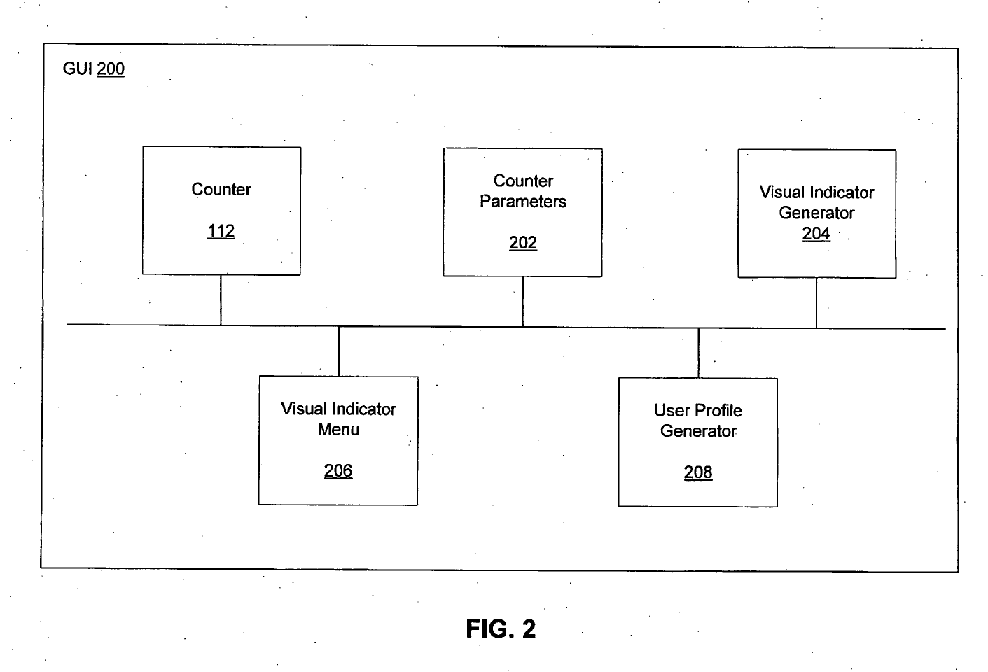

Referring now to FIG. 2, a graphical user interface (GUI) engine 200 for interfacing with the visual indicator 108 is shown, in one embodiment in accordance with the present invention. As discussed herein, the server 110 may include the counter 112. Counter parameters 202 may be entered and/or defaulted. For example, a system administrator may modify the counter parameters 202 via the GUI 200. The counter parameters 202 may specify which magnitudes are to be measured by the counter 112. For example, the counter 112 may measure the number of users interacting with the network space 104 generally and/or the counter 112 may measure the number of users that interact with individual photos within the network space 104. Accordingly, the counter parameters 202 may specify which interactions should be counted or measured by the counter 112. More than one item within the network space 104 may be measured according to exemplary embodiments.

A visual indicator generator 204 may be provided for generating the visual indicator 108. As discussed herein, the visual indicator 108 may include any symbol, icon, and so forth. The visual indicator generator 204 may be utilized to create, modify, and/or import symbols, icons, and such to utilize as the visual indicator 108. Any user can generate the visual indicator 204. In some embodiments, the visual indicator 204 may be selected from a menu of visual indicators 204.

In some embodiments, one or more users associated with the client(s) 102 can select or generate the visual indicator 108 to represent various items, persons, and/or scenarios associated with the network space 104 with which the user is interacting. For example, the user may select an icon that represents the user in the network space 104 as a player in an online game. The counter 112 then increases the size, for example, of the icon selected by the user as the user gains more points in the online game. The user may also generate or import the icon to represent the user in the online game. The visual indicator 108 may be selected, modified, and/or generated by the user to represent any opinion, items, person, scenario, and so forth according to various embodiments.

A visual indicator menu 206 may be provided for presenting users with potential visual indicators 108 and/or characteristics to associate with the visual indicator 108. As discussed herein, the users may comprise a system administrator, a network space visitor, or any other users. The visual indicator menu 206 may be utilized to select the visual indicator 108 for the particular network space 104 for which the counter 112 is measuring user interaction. For example, an icon may be selected from the visual indicator menu 206 for representing magnitudes related to the icon on the network space 104 for which the icon is selected. For instance, a dollar bill icon or dollar symbol may be selected for measuring the magnitude of donations contributed via the particular network space 104. The dollar bill icon or dollar symbol may become brighter or have an increased “halo effect” as more contributions are received via the network space 104. Any type of icon, symbol, and so forth may be selected as the visual indicator 108 from the visual indicator menu 206.

In some embodiments, characteristics associated with the visual indicator 108 may also be selected from the visual indicator menu 206. For example, the halo effect discussed herein may be selected as a characteristic to associate with the selected visual indicator 108 from the visual indicator menu 206. Any type of characteristic may be selected from the visual indicator menu 206. For example, a color characteristic may be chosen to associate with the visual indicator 108. The color characteristic may further be characterized by changing colors, becoming darker, becoming lighter or brighter, and so on in response to user interaction with the network space 104 as a result of the specific effect selected. Alternatively, the user may generate characteristics and/or effects to associate with the visual indicator 108 by utilizing the visual indicator generator 204.

A user profile generator 208 may also be provided. The user profile generator 208 may be utilized to group users whose activity is being measured into one or more user profiles. The user profiles may then each be assigned a different visual indicator 108 so that the user activities related to the individual visual indicators 108 for each user profile grouping can be measured. The user profile generator 208 or the visual indicator generator 204 may be utilized to assign the particular visual indicator 108 to the user profile(s).

The user profile generator 208 may also be utilized to define characteristics and/or parameters to associate with one or more users. The counter 112 may then measure various types of user activities and/or interaction with the network space 104 according to the defined characteristics and/or parameters. For example, if the user profile is defined as “users that show a keen interest in advertisements” in the network space 104, the counter 112 may ignore users that interact with the network space 104, but not with the advertisements in the network space 104. Accordingly, the visual indicator 108 may only be modified when the users fitting into the particular user profile created by the user profile generator 208 interact with the advertisements.

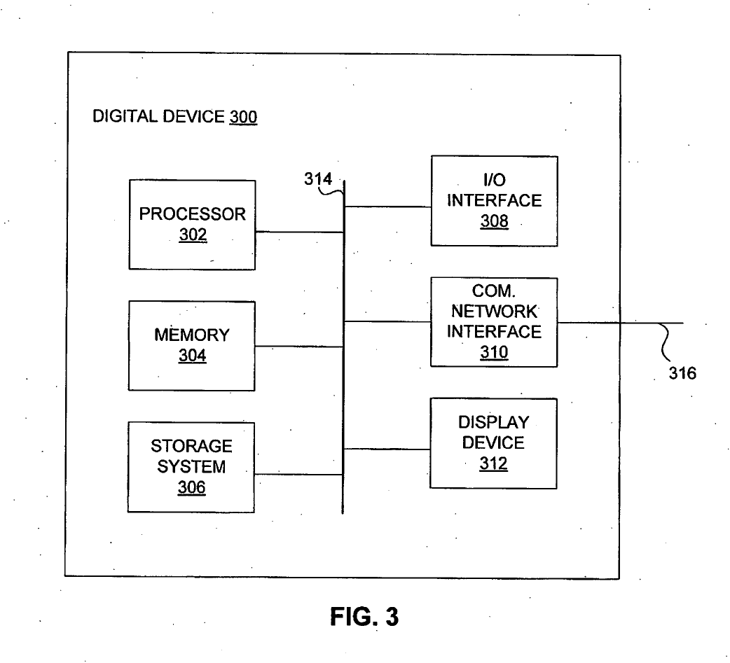

FIG. 3 illustrates a digital device 300 for implementing the visual indicator 108 and the GUI 200, in one embodiment in accordance with the present invention. The digital device 300 is any device that may be implemented either in hardware, software, or both. Examples of digital devices 300 include, but are not limited to, computers, servers, terminals, personal digital assistants, cell phones, laptops, computing tablets, and personal media devices. The digital device may be a node on the network 106.

The digital device 300 includes a system bus 314 coupled to a processor 302, memory 304, storage system 306, input/output (I/O) interface 308, communications (com.) network interface 310, and a display device 312. The communications network interface 310 is further coupled to an external communications link 316.

The processor 302 is configured to execute software instructions. The memory 304 is any memory device configured to hold data, permanently and/or temporarily, to make the data available to any components connected to the system bus 314. The memory 304 may be configured to hold the application level visual indicator 108.

The storage system 306 is any storage device or group of storage devices configured to store data permanently and/or temporarily. The storage system 306 may be configured to store the application level visual indicator 108.

The I/O interface 308 is any interface or device configured to provide input or output to a user of the digital device 300. For example, the I/O interface 308 may include a video interface, a remote control, a keypad, joystick, touch-screen, or buttons.

The communications network interface 310 is any communication interface configured to transfer data between any components connected to the system bus 314 and any communications network (e.g., the network 106) over the external communications link 316. The display device 312 is any device configured to visually interact with the user of the digital device 300. For example, the display device 312 may be a television screen, a monitor, a display for a cell phone, a display for a personal digital assistant, or a terminal display.

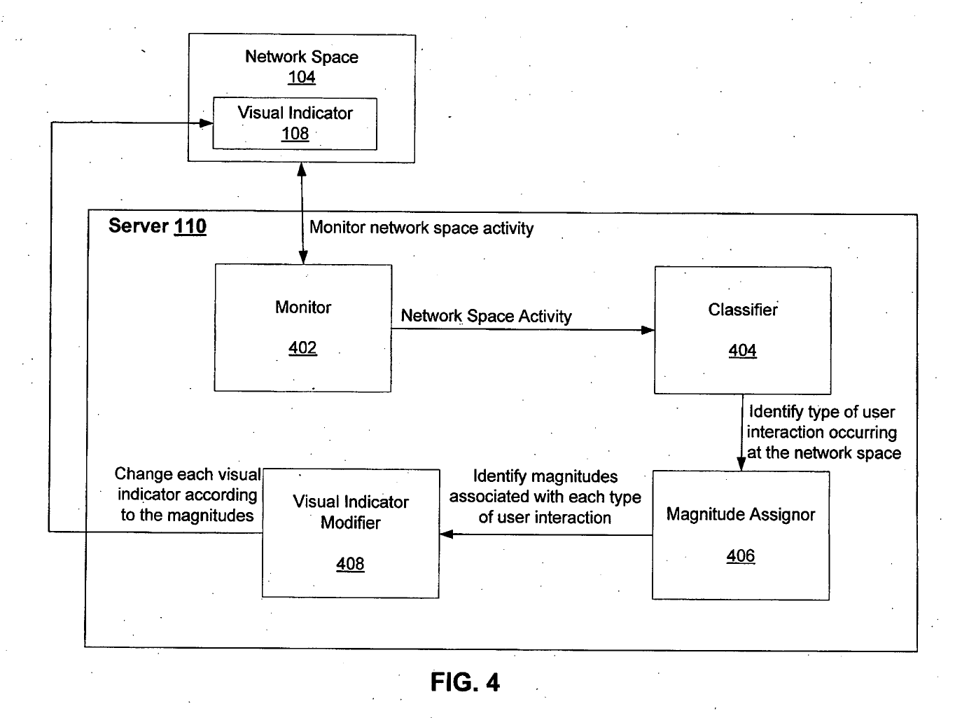

Turning to FIG. 4, exemplary server 110 activity for modifying the visual indicator 108 in response to user activity is illustrated, in one embodiment in accordance with the present invention. The server 110 may include a monitor 402. The monitor 402 tracks user activities occurring at the network space 104. As discussed herein, the user activities monitored may change according to user profiles. Accordingly, the monitor 402 may simultaneously monitor various activities or interactions occurring at the network space 104.

The monitor 402 forwards network space activities detected by the monitor 402 to a classifier 404. The classifier 404 then identifies the type of user interaction or activities occurring at the network space 104. For example, the classifier 404 may classify the interactions as pure counts of how many users visit the network space 104 within a specified or defined period, how many users voted for a candidate or other subject matter associated with the network space, and so on.

Any period for tracking user activities or interactions at the network space 104 may be specified. In some embodiments, a default period for tracking and classifying user activities and interactions is provided. A user can modify the default period for tracking activities hourly, daily, weekly, and so on.

The classifier 404 forwards the user interaction identified by the classifier 404 to a magnitude assignor 406. The magnitude assignor 406 can access counter parameters 202 or any other data in order to determine how the magnitude of the visual indicator 108 should be adjusted according to the type of user activity or interaction identified. Several visual indicators 108 at the same network space 104 may need to be modified according to the identified user activity or interaction. For example, an advertisement may enlarge as more users interact with the advertisement, a frame around a news article may become brighter as more users interact with the news article, and an icon representing a game participant may shrink or become duller as the game participant's points fail to increase while other online game participant's increase their points. As discussed herein, any type of magnitude indications may be assigned to the visual indicator 108 to identify various changes to items or people represented by the visual indicators 108.

Once the magnitude assignor 406 identifies magnitudes associated with each type of user interaction, a visual indicator modifier 408 adjusts the visual indicators 108 accordingly, as discussed herein. Thus, the magnitude for the visual indicators 108 is adjusted up or down, depending upon whether the user activity or interaction monitored by the monitor 402 showed an increase or decrease according to the type of user activity or interaction. The visual indicator modifier 408 specifically adjusts the characteristics or effects associated with the visual indicators 108, as discussed herein. The monitor 402 continues to monitor user activities and interactions and the visual indicator modifier 408 continues to change the visual indicators 108 according to the activities and interactions detected. Although various components have been described in association with the server 110, fewer or more components may comprise the server 110 and still fall within the scope of various embodiments.

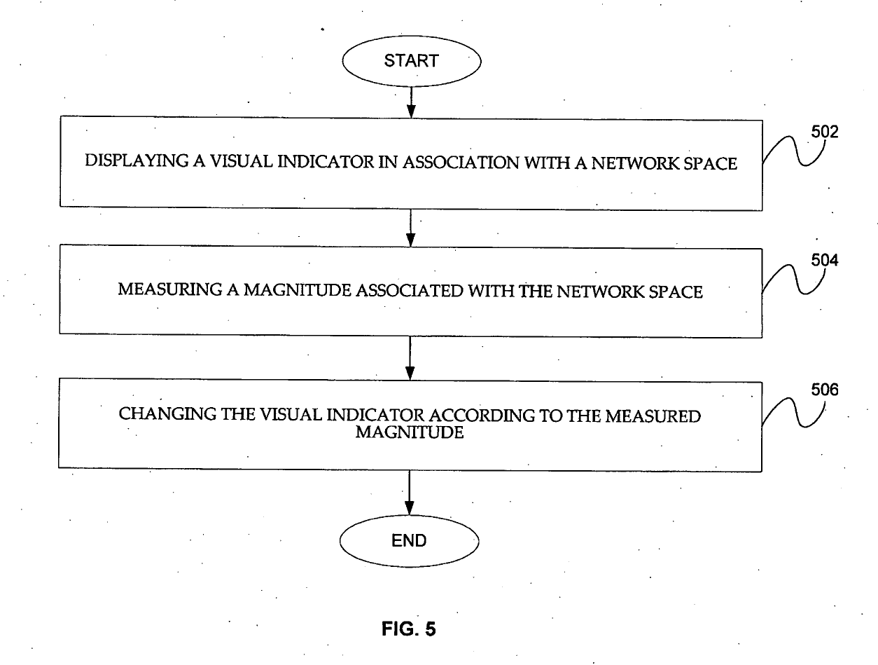

FIG. 5 illustrates a flow diagram of an exemplary process for providing the visual indicator 108 to indicate magnitude, in one embodiment in accordance with the present invention. At step 502, a visual indicator, such as the visual indicator 108 discussed herein, is displayed in association with a network space, such as the network space 104 discussed herein. The network space 104 may comprise a web site, a web page, a file on the network 106, a multi-user game space, or any other network space 104.

At step 504, a magnitude associated with the network space 104 is measured. The visual indicator 104 is displayed at the network space 104 for indicating magnitude associated with subject matter, topics, game players, type of user, users, and so forth. Any type of magnitude may be measured and indicated via the visual indicator 108 according to various embodiments.

As discussed herein, the counter 112 may measure the magnitude. Any type of magnitude may be measured. Further, more than one magnitude in association with one network space 104 may be measured. For example, the magnitude of a number of users that visit a web site may be measured, the magnitude of a number of users that support one or more items associated with the web site may be measured, and/or the magnitude may correspond with a type of user associated with the web site. As another example, the magnitude may be utilized to measure the number of users that interact with the file on the network 106, discussed herein.

At step 506, the visual indicator 108 is changed according to the measured magnitude. The monitor 402, the classifier 404, the magnitude assignor 406, and the visual indicator modifier 408 may also, optionally, be utilized in coordination with the counter 112 for measuring magnitude and/or modifying the visual indicator 108. As discussed herein, any changes may be made to the visual indicator 108. Typically, the changes to the visual indicator 108 provide evidence of changes to subject matter or persons represented by the visual indicator 108, itself. However, any changes may be made to the visual indicator 108. As discussed herein, the visual indicator 108 may be customized in order specify characteristics to associate with the visual indicator 108, such as how the visual indicator 108 should be changed to reflect user interactions or activity detected, what type of visual indicator 108 should be displayed for various scenarios, and so forth.

While various embodiments have been described above, it should be understood that they have been presented by way of example only, and not limitation. For example, any of the elements associated with the visual indicator 108 may employ any of the desired functionality set forth hereinabove. Thus, the breadth and scope of a preferred embodiment should not be limited by any of the above described exemplary embodiments.

What is claimed is:

1. A method for providing a visual indicator of magnitude comprising:
displaying a visual indicator in association with a network space;
measuring a magnitude associated with the network space; and
changing the visual indicator according to the measured magnitude.

2. The method recited in claim 1, wherein the network space comprises a web site.

3. The method recited in claim 2, wherein the magnitude comprises a number of users that visit the web site.

4. The method recited in claim 2, wherein the magnitude comprises a number of users that support one or more items associated with the web site.

5. The method recited in claim 2, wherein the magnitude corresponds with a type of user associated with the web site.

6. The method recited in claim 1, wherein the network space comprises a file on the network.

7. The method recited in claim 6, wherein the magnitude comprises a number of users that have interacted with the file.

8. The method recited in claim 1, wherein the network space comprises a multi-user game space.

9. The method recited in claim 8, wherein the magnitude comprises a type of user logged into the game space.

10. The method recited in claim 1, further comprising customizing the visual indicator.

11. The method recited in claim 1, further comprising associating one or more user profiles with the visual indicator.

12. A method for providing a visual indicator of magnitude comprising:
a network space configured to display a visual indicator;
a counter configured to measure a magnitude associated with the network space; and
a visual indicator modifier configured to change the visual indicator according to the measured magnitude.

13. The system recited in claim 12, wherein the network space comprises a web site.

14. The system recited in claim 13, wherein the magnitude comprises a number of users that visit the web site.

15. The system recited in claim 13, wherein the magnitude comprises a number of users that support one or more items associated with the web site.

16. The system recited in claim 13, wherein the magnitude corresponds with a type of user associated with the web site.

17. The system recited in claim 16, wherein the network space comprises a file on the network.

18. The system recited in claim 17, wherein the magnitude comprises a number of users that have interacted with the file.

19. The system recited in claim 12, wherein the network space comprises a multi-user game space.

20. The system recited in claim 8, wherein the magnitude comprises a type of user logged into the game space.

21. The system recited in claim 12, further comprising a visual indicator generator configured to allow a user to customize the visual indicator.

22. The system recited in claim 12, further comprising a user profile generator configured to allow a user to associate one or more user profiles with the visual indicator.

23. A computer program embodied on a computer readable medium having instructions for providing a visual indicator of magnitude comprising:
displaying a visual indicator in association with a network space;
measuring a magnitude associated with the network space; and
changing the visual indicator according to the measured magnitude.

24. The computer program recited in claim 23, wherein the network space comprises a web site.

25. The computer program recited in claim 24, wherein the magnitude comprises a number of users that visit the web site.

26. The computer program recited in claim 24, wherein the magnitude comprises a number of users that support one or more items associated with the web site.

27. The computer program recited in claim 24, wherein the magnitude corresponds with a type of user associated with the web site.

28. The computer program recited in claim 23, wherein the network space comprises a file on the network.

29. The computer program recited in claim 28, wherein the magnitude comprises a number of users that have interacted with the file.

30. The computer program recited in claim 23, wherein the network space comprises a multi-user game space.

31. The computer program recited in claim 40, wherein the magnitude comprises a type of user logged into the game space.

32. The computer program recited in claim 23, further comprising customizing the visual indicator.

33. The computer program recited in claim 23, further comprising associating one or more user profiles with the visual indicator.
